(19) United States
(12) Patent Application Publication
(10) Pub. No.: US 2013/0137072 A1
(43) Pub. Date: May 30, 2013

(54) TEST AND METHOD FOR DETECTION OF EXCESSIVE FATIGABILITY AS INDICATOR OF SUBCLINICAL DEPRESSION OR PREDICTOR OF UPCOMING DEPRESSION

(71) Applicant: Ernest A. Graypel, Independence, MO (US)

(72) Inventor: Ernest A. Graypel, Independence, MO (US)

(21) Appl. No.: 13/691,500

(22) Filed: Nov. 30, 2012

Related U.S. Application Data
(60) Provisional application No. 61/565,139, filed on Nov. 30, 2011.

(51) Int. Cl. G09B 19/00

(52) U.S. Cl. CPC G09B 19/00
USPC 434/236

(57) ABSTRACT

A test or system for detection of increased/excessive fatigability and as a screening tool for on- or up-coming depression, and Chronic Fatigue Syndrome. Fatigue is dissected into components including general feelings, activity, and emotions, each expressed through sets or pairs of opposite feelings. Between the opposite feelings there is a scale, from which the person will select the most applicable point that best reflects the person's present feelings. The scale is scored, and based on the score it is determined whether to perform the test again, or to evaluate for depression. If the test is performed again, need for further evaluation is determined from that score.

### TECHNICAL FIELD

This invention relates generally to a test and method for detecting fatigability predictive of oncoming depression.

### BACKGROUND ART

It is well known that people with chronic medical problems (such as chronic pain syndrome, sleep apnea, and others) generally express decreased level of functioning. Most of the medical textbooks describe these patients as being fatigued and even anxious and depressed, but these descriptions are very subjective and no authors offered a detection of excessive fatigability as a key element in early diagnosis of upcoming depression or identified increased fatigability as a sign of sub-clinical depression.

### The Fatigue Scale.

The term “Fatigue” is not well defined in the literature. It is generally a subjective expression of person feeling lack of energy, being apathetic or slightly irritable.

What is sought therefore, is a manner, specifically a test, to bring objectivity to people's expression of fatigue, which can be utilized for detection of increased/excessive fatigability and as a screening tool for on- or up-coming depression, and Chronic Fatigue Syndrome.

### SUMMARY OF THE INVENTION

What is disclosed is a manner, specifically a test or system, to bring objectivity to a person's expression of fatigue, which can be utilized for detection of increased/excessive fatigability and as a screening tool for on- or up-coming depression, and Chronic Fatigue Syndrome.

According to a preferred aspect of the invention, fatigue is dissected into its main components—general feelings, activity, and emotions, and each of these components is expressed through sets or pairs of opposite feelings. Between opposite feelings there is a scale, from which the person will select the most applicable point in a range between associated words that best reflects the person's present feelings.

According to another preferred aspect of the invention, the increased fatigability is determined by analysis of a summation of values for the selected points within the ranges selected by the subjects. The questionnaire will be administered at a first time during a 24 hour period and scored, and if deemed appropriate, again at a second time. As a non-limiting example, first at mid-morning, then at mid-afternoon. A summation of the second or mid-afternoon results more than a threshold value, e.g., 30 percent, greater than the first or mid-morning results will determine that further evaluation for onset of depression is warranted. The screening for a Chronic Fatigue Syndrome (CFS) is preferably done using mid-morning test results only and will be determined as a function of the summation. Preferably, if a total number of points on the morning part of the test is significantly increased compared to that of general population, the test would need to be repeated at a later time, e.g., in two weeks. Similar results on repeated test will be diagnostic for CFS.

Each of the subjects will preferably be tested twice per day (e.g., mid-morning and mid-afternoon—this is desired to eliminate possible effects of certain conditions, most importantly, eating, e.g., postprandial hyper-or hypo-glycemia). The subjects will be asked to complete a simple questionnaire (“The Fatigue Scale”). The questionnaire can also or alternatively be administered at certain times, e.g., before, after, or during certain events, such as work, travel, etc., to enable determining when onset or occurrence of fatigability is more likely, and/or possible causes or related conditions, e.g., anxiety, etc., may be present.

Upon completion, the scales are analyzed and conclusions are derived. Conclusions are drawn after simple summation of the results, with a maximum score possible, each of the pairs or sets of associated words to be scored equally, there being preferably a range of 10 selectable points between the associated words.

The following illustrates a preferred manner of interpreting the conclusions: if the mid-morning test results are below a first predetermined threshold value, the person is not fatigued and no further work-up is needed. If the total number of points is over a second predetermined value, the person is likely to be depressed and further workup with conventional depression tests is recommended. If the total number of points on the mid-morning test is within a predetermined intermediate range, preferably between the first threshold value and the second, the same test (The Fatigue Scale) is to be repeated in mid-afternoon. If the mid-afternoon score is above a third predetermined threshold value, the testing for depression (again, by conventional methods) is recommended. If the mid-afternoon score is not above the third predetermined threshold value, patient is most likely not depressed at that time (just tired or have some underlying medical condition that may need to be considered) and the same 2-step (morning and afternoon) test is to be repeated sometime during the following week or (which is preferable) during weekend. The second test's results may rule out necessity for additional screening (if the total score is within “normal” range) or become diagnostic for a Chronic Fatigue Syndrome.

Recommendation that “The Fatigue Scale” can be utilized as a screening tool to indicate necessity for further evaluation of the patient for depression or anxiety, or as a diagnostic tool for a chronic fatigue syndrome.

### BRIEF DESCRIPTION OF THE DRAWINGS

FIG. 1 is a diagrammatic illustration showing elements of an embodiment of a questionnaire of the invention;

FIG. 2 is a continuation of the diagrammatic illustration of FIG. 1;

FIG. 3 is a continuation of the illustration of FIGS. 1 and 2; and

FIG. 4 is a high level flow diagram showing steps of a method of the invention.

### DETAILED DESCRIPTION OF THE INVENTION

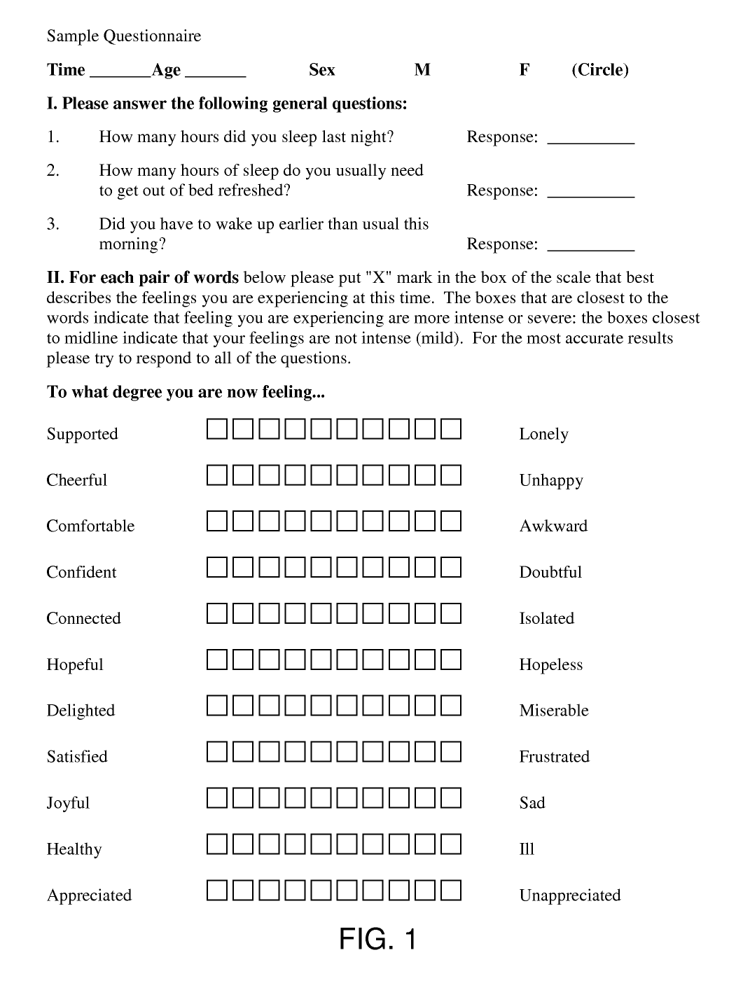

Referring to the drawings, FIGS. 1-3 show a preferred embodiment of a questionnaire comprising of the system and method of the invention. In the questionnaire, indicators of fatigue are dissected into main components—general feelings, activity, and emotions, and each of these components is expressed through pairs of opposite feelings. Between opposite feelings there is a point scale, preferably, from “0” to “10” or (in computerized version) just a box to click in. The person selects the box that most accurately reflects his or her feeling between or relative to the associated pairs of opposite feelings. A value of “1” is assigned to the leftmost box, and “10” to the rightmost box, with values of “2” through “9” assigned to the other respective boxes from left to right. The values for the boxes selected by the person are then summed.

For scoring the summed results, increased fatigability is determined by presence of over 30% increase in total number of mid-afternoon points compared to that of mid-morning test. The screening for a Chronic Fatigue Syndrome (CFS) is preferably done using mid-morning test results only. If a total number of points on the morning part of the test is significantly increased compared to that of general population, the test would need to be repeated at a later time, e.g., in two weeks. Similar results on repeated test will be diagnostic for CFS.

### Method:

Each of the subjects will preferably be tested twice per day (e.g., mid-morning and mid-afternoon—this is desired to eliminate possible effects of eating, e.g., postprandial hyper-or hypo-glycemia). The subjects will be asked to complete a simple questionnaire (“The Fatigue Scale”). The questionnaire can also or alternatively be administered at certain times, e.g., before, after, or during certain events, such as work, travel, etc., to enable determining when onset or occurrence of fatigability is more likely, and/or possible causes or related conditions, e.g., anxiety, etc., may be present.

Upon completion, the scales are analyzed and conclusions are derived.

### Conclusions:

Conclusions are drawn after simple summation of the results (maximal score—400 points for the representative questionnaire).

The following illustrates a preferred manner of interpreting the conclusions:

If the mid-morning test results are 0-149 (less than a first predetermined threshold value of 150) points—the person is not fatigued and no further work-up is needed.

If the total number of points is greater than a second predetermined threshold value, here, 279—the person is likely to be depressed and further workup with conventional depression tests is recommended.

If the total number of points on mid-morning test is in a predetermined range, here preferably between 150 and 279 (here the first and second thresholds), the same test (The Fatigue Scale) is to be repeated in mid-afternoon.

If the mid-afternoon score is greater than a third predetermined threshold value, which can be, for instance, but is not limited to, a value that is about 30 percent greater than the value of the mid-morning score for that person, the testing for depression (again, by conventional methods) is recommended.

If mid-afternoon score is not above the about 30 percent greater threshold, the patient is most likely not depressed at that time (just tired or have some underlying medical condition that may need to be considered) and the same 2-step (morning and afternoon) test is to be repeated sometime during the following week or (which is preferable) during weekend. The second test's results may rule out necessity for additional screening (if the total score is within “normal” range) or become diagnostic for a Chronic Fatigue Syndrome. As an alternative possible evaluative method, a third threshold of a fixed value can be used, for instance, but not limited to, a score of 210, which is equal to about the mid-point of the 140-279 range of scores for determining the need for the second test.

### Expected Results:

Recommendation that “The Fatigue Scale” can be utilized as a screening tool to indicate necessity for further evaluation of the patient for depression or anxiety, or as a diagnostic tool for a chronic fatigue syndrome.

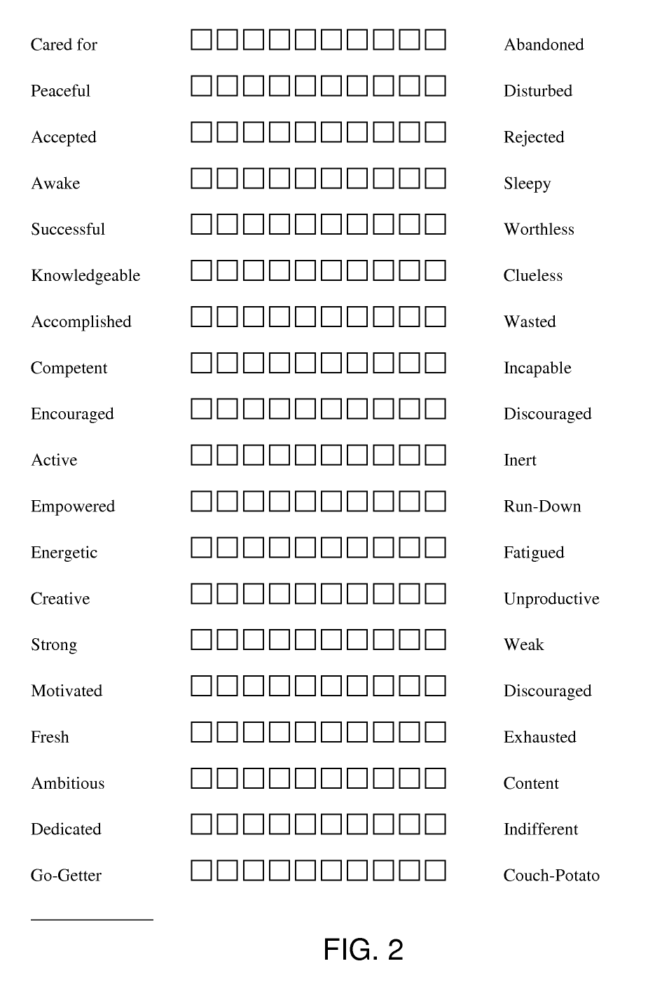

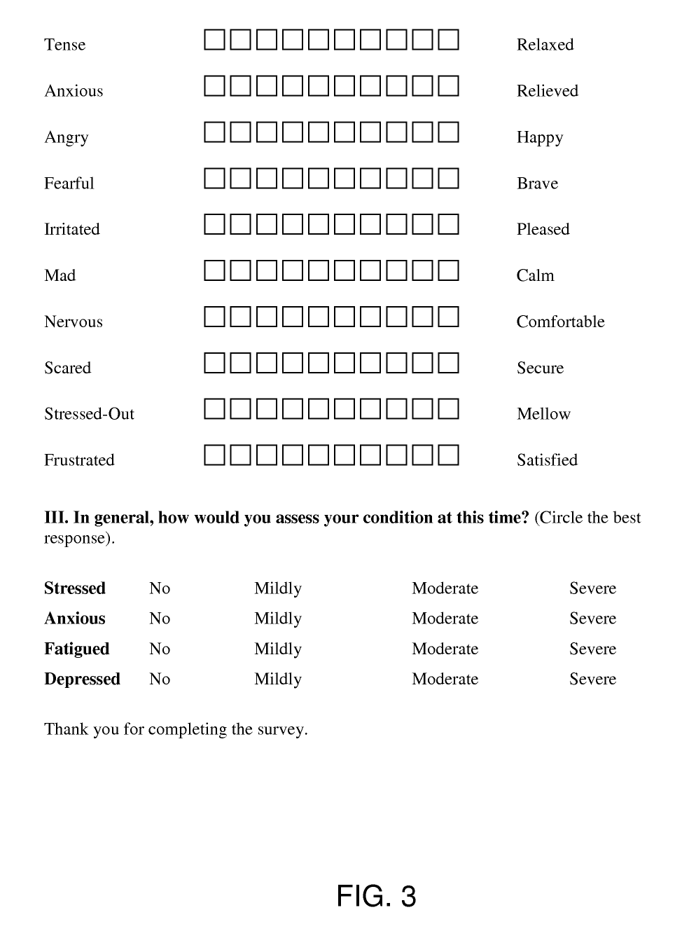

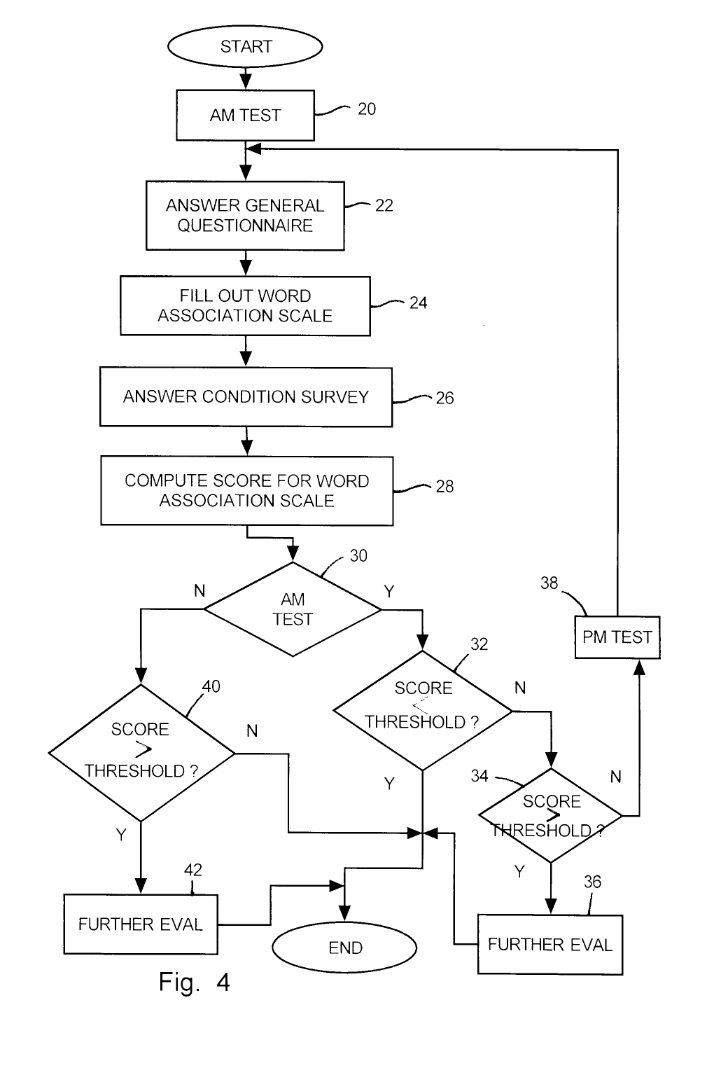

Referring also to FIG. 4, a flow diagram showing steps of the system and method of the invention is shown. In block 20, the first or mid-morning test, is administered. The test-taker answers the general questionnaire, such as that illustrated in FIG. 1, as denoted by block 22. Next, the word association scale is administered or filled out, e.g., as shown in FIGS. 2-3, selecting the best point or box that represents the person's feeling as between the two words of each word pair, as denoted by block 24. The condition survey is then answered, as denoted by block 26. Scores for the word association scale are computed, e.g., summed, as denoted by block 28. It is next determined if the test is the first or AM (mid-morning) test, as denoted at decision block 30. If yes, then it is next determined if the score is less than the first threshold value, as denoted at decision block 32. If also yes, then no further test is needed at this time. If at decision block 32 the score is greater than the first threshold value, it is determined if the score is greater than the second predetermined threshold value, as denoted at decision block 34. If yes, further evaluation for depression is indicated, as denoted at block 36. If at block 34 the answer is no, then the second or mid-afternoon test is administered, as denoted at block 38, and the process returns to block 22 and the test is administered again and the results tabulated, as denoted by blocks 22-28. At block 30, if the present test is not the AM test, the process proceeds to decision block 40, where it is determined whether the score is greater than the third predetermined threshold value requiring further evaluation, as denoted by block 42, if not, then the testing is complete and further testing is not indicated.

In light of all the foregoing, it should thus be apparent to those skilled in the art that there has been shown and described a TEST AND METHOD FOR DETECTION OF EXCESSIVE FATIGABILITY AS INDICATOR OF SUBCLINICAL DEPRESSION OR PREDICTOR OF UPCOMING DEPRESSION. However, it should also be apparent that, within the principles and scope of the invention, many changes are possible and contemplated, including in the details, materials, and arrangements of parts which have been described and illustrated to explain the nature of the invention. Thus, while the foregoing description and discussion addresses certain preferred embodiments or elements of the invention, it should further be understood that concepts of the invention, as based upon the foregoing description and discussion, may be readily incorporated into or employed in other embodiments and constructions without departing from the scope of the invention. Accordingly, the following claims are intended to protect the invention broadly as well as in the specific form shown, and all changes, modifications, variations, and other uses and applications which do not depart from the spirit and scope of the invention are deemed to be covered by the invention, which is limited only by the claims which follow.

What is claimed is:

1. A method for detecting fatigability as an indicator of on-coming depression, comprising steps of:
during a first predetermined time period during a day, administering a test to a person wherein the person is presented with a plurality of word pairs representative of different feelings, and the person will rate their present feelings by selecting a point within a range between the words of the pairs, respectively;
scoring the selected points within the ranges, and:
a. if the score is less than a first predetermined threshold value, then ceasing testing;
b. if the score is greater than a second predetermined threshold value, then evaluate the person for depression; and
c. if the score is between the first threshold value and the second threshold value, then administering the test to the person again during a second predetermined time period during the day; and
scoring the selected points for the second administered test within the ranges, and
a. if the score of the second administered test is less than a third predetermined threshold value, then ceasing testing; and
b. if the score of the second administered test is greater than the third predetermined threshold value, then evaluating the person for depression.

2. The method of claim 1, wherein the third predetermined threshold value is set as a value about 30 percent greater than the score for the test during the first predetermined time period during the day.

3. The method of claim 1, wherein the test comprises about 40 of the word pairs.

4. The method of claim 1, wherein the range between the words of each of the pairs comprises about 10 points.
